(19) United States
(12) Patent Application Publication
(10) Pub. No.: US 2020/0409678 A1
(43) Pub. Date: Dec. 31, 2020

(54) VEHICLE SOFTWARE UPDATE NETWORK

(71) Applicant: GM Global Technology Operations LLC, Detroit, MI (US)

(72) Inventors: Xi Ju, Troy, MI (US); Lakshmi V. Thanayankizil, Rochester Hills, MI (US); Fan Bai, Ann Arbor, MI (US); John Sergakis, Bloomfield Hills, MI (US); Michael C. Heitmann, Shelby Township, MI (US)

(21) Appl. No.: 16/451,742

(22) Filed: Jun. 25, 2019

(51) Int. Cl. G06F 8/65; G06F 21/57; G07C 5/00; H04W 4/40

(52) U.S. Cl. CPC G06F 8/65; H04W 4/40; G07C 5/008; G06F 21/57

(57) ABSTRACT

Embodiments include methods, systems, and computer readable storage medium for a method for providing a software update to a vehicle is disclosed. The method includes entering, by a vehicle, a wakeup state. The method further includes sending, by the vehicle, a vehicle registration request to a computing environment. The method further includes receiving, by the vehicle, a confirmation that the vehicle is to receive one or more software updates based on the vehicle registration of the vehicle. The method further includes receiving, by the vehicle, the one or more software updates from the computing environment.

### INTRODUCTION

The subject disclosure relates to software for vehicles, and more specifically to providing software updates to vehicles using an over-the-air network.

Advances in technology have led to substantial changes in the design of vehicles. Modern vehicles include a number of electronic components, such as, for example, engine control units (ECUs), traction control systems, power steering systems, braking systems, climate control systems, navigation systems, infotainment systems, and the like. Additionally, modern vehicles often are capable of supporting communications to/from external components, for example, via external communications networks (e.g., cellular networks, wireless networks, personal area networks, or the like) or a physical interface (e.g., a bus interface or the like).

During the lifetime of a vehicle, it may be desirable to reprogram or otherwise update one or more of the vehicle electronic components, for example, to support or otherwise provide new features and/or functionality or to resolve potential issues with existing features and/or functionality. Allowing vehicles to receive updates or otherwise be reprogrammed from an external component poses numerous cybersecurity risks and logistical issues. In addition, vehicles in production line can only rely on a manual update with harnesses, which is inefficient and time-consuming. Accordingly, it is desirable to provide systems and methods for securely programming vehicle electronic components in an efficient and secure manner.

### SUMMARY

In one exemplary embodiment, a method for providing a software update to a vehicle is disclosed. The method includes entering, by a vehicle, a wakeup state. The method further includes sending, by the vehicle, a vehicle registration request to a computing environment. The method further includes receiving, by the vehicle, a confirmation that the vehicle is to receive one or more software updates based on the vehicle registration of the vehicle. The method further includes receiving, by the vehicle, the one or more software updates from the computing environment.

In addition to one or more of the features described herein, one or more aspects of the described method recognize that the vehicle registration request includes a dedicated key and credential registration file. Another aspect of the method is that the confirmation is a short message service (SMS). Another aspect of the method performs a data allocation analysis on a network associated with the computing environment. Another aspect of the method transfers the one or more software updates based on compute and network connectivity capabilities determined in the data allocation analysis. Another aspect of the method is that the vehicle receives the one or more updates from an assigned access point. Another aspect of the method is that the access point is a part of a mesh network associated with a vehicle update location. Another aspect of the method performs a download time prediction in response to receiving the one or more software updates. Another aspect of the method cancels the one or more software updates in response to a transfer time exceeding the download time prediction.

In another exemplary embodiment, a system for providing a software update to a vehicle is disclosed herein. The system includes a vehicle having a memory and a processor coupled to the memory, one or more servers, each of which include a memory and a processor coupled to the memory and a plurality of access points. The processor of the vehicle is operable to cause the vehicle to enter a wakeup state. The processor of the vehicle is further operable to send a vehicle registration request to the one or more servers via one or more of the plurality of access points. The processor of the vehicle is further operable to receive a confirmation that the vehicle is to receive one or more software updates based on the vehicle registration of the vehicle from the one or more servers via one or more of the plurality of access points. The processor of the vehicle is further operable to receive the one or more software updates from the one or more servers via one or more of the plurality of access points.

In yet another exemplary embodiment a computer readable storage medium for performing a method for providing a software update to a vehicle is disclosed herein. The computer readable storage medium includes entering a wakeup state. The computer readable storage medium further includes sending a vehicle registration request to a computing environment. The computer readable storage medium further includes receiving a confirmation that the vehicle is to receive one or more software updates based on the vehicle registration of the vehicle. The computer readable storage medium further includes receiving the one or more software updates from the computing environment.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a computing environment according to one or more embodiments;

FIG. 2 is a block diagram illustrating one example of a communications system for practice of the teachings herein;

FIG. 3A depicts a first portion of a flow diagram of a method for providing a software update to a vehicle according to one or more embodiments; and

FIG. 3B depicts a second portion of the flow diagram of the method for providing a software update to a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

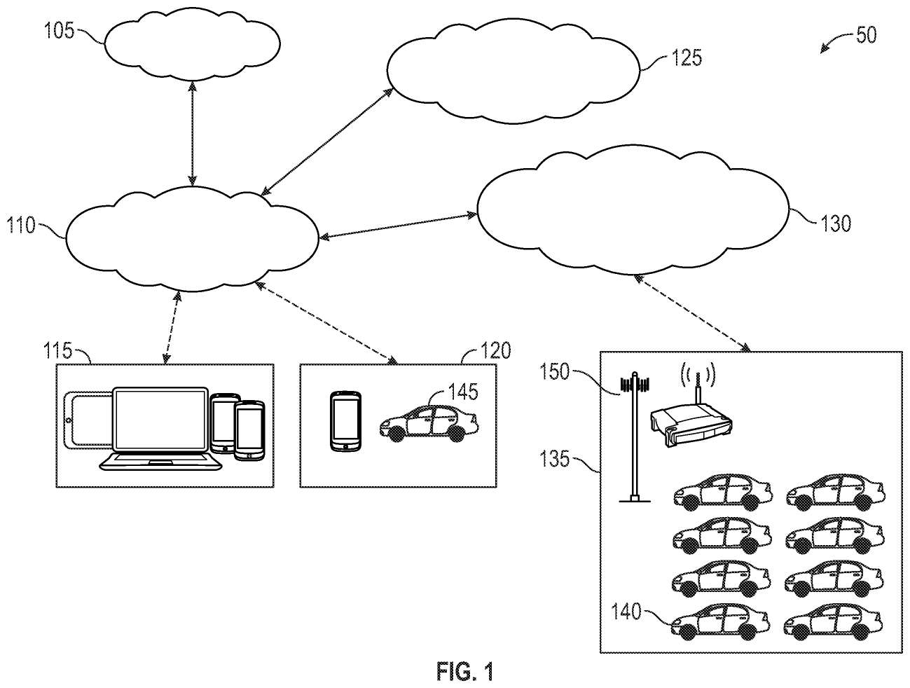

In accordance with an exemplary embodiment, FIG. 1 illustrates a computing environment 50 associated with a system for performing a software update over a network according to one or more embodiments. As shown, the computing environment 50 comprises one or more computing devices and systems, for example, a credential validation server 105, cloud 110, user computing device 115, mobile device 120, external validation system 125, an enterprise network and a vehicle update location 135 where one or more vehicles 140 are located.

Each of the one or more computing devices and systems are connected and communicate one or more networks. The one or more networks can be, for example, a cellular network, a local area network (LAN), a wide area network (WAN), such as the Internet and WIFI, a dedicated short-range communications network (for example, V2V communication (vehicle-to-vehicle), V2X communication (i.e., vehicle-to-everything), V2I communication (vehicle-to-infrastructure), and V2P communication (vehicle-to-pedestrian)), or any combination thereof, and may include wired, wireless, fiber optic, or any other connection. The one or more networks can be any combination of connections and protocols that will support communication between one or more computing devices and systems.

The credential validation server 105 can receive requests for a public key infrastructure (PM) private/public key pair and/or a digital certificate. The request message can include, for example, a signature or a vehicle identification number (VIN) associated with each of the one or more vehicles 140 and vehicle 145. The credential validation server 105 can create a new PM private/public key pair (and/or a digital certificate) for storage with the VIN. The new PM private/public key pair can also be used to pair end devices (computing device 115, mobile device 120, etc.) or exchange information with the external validation system 125 and/or enterprise network 130 and the cloud 110 during a software update.

The cloud 110 can be, for example, an OnStar server. The cloud 110 can receive and/or transmit vehicle system and/or subsystem information from vehicle system modules (VSMS) of the one or more vehicles 140 and vehicle 145. Cloud 110 can be used to exchange vehicle registration and other customer information via the computing device 115. Cloud 110 can exchange data with the mobile device 120. The information exchanged between the mobile device 120 and the cloud 110 can be used to enroll and reserve vehicles and/or services for vehicles. Cloud 110 can associate and keep track of a current firmware version for each of the one or more vehicles 140 and vehicle 145, as well as communicate with the external validation system 125 to receive new updates for the one or more vehicles 140 and vehicle 145. The cloud 110 also maintains certificate information for ensuring updates are sent to the proper enterprise network 130 to provide the software update to the correct vehicle.

Cloud 110 can be implemented as a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

The external validation system 125 can be used to validate a system package and perform a flash integrity check. The external validation system 125 can also ensure each file included with the software update is evaluated for authentication and integrity.

The enterprise network 130 can be associated with a vehicle manufacturer/original equipment manufacturer (OEM). The enterprise network 130 can comprise files used for the operation of a vehicle, which can be downloaded/transmitted to one or more vehicles, e.g., vehicles 140 and vehicle 145, which are maintained by one or more servers of the enterprise network (e.g., a cache server, a RAP server, etc.). The enterprise network 130 can also store files used to update one or more vehicles parked at an associated vehicle update location 135.

The enterprise network 130 can maintain vehicle location and tracking information and one or more vehicles 140. The enterprise network 130 can connect to the cloud 110 via an interface which can be used to manage reservation and tracking of updates for the one or more vehicles. Multiple enterprise networks 130 can be used in system 50, each of which can be connected to an associated vehicle update location 135.

The vehicle update location 135 can be a location at which one more vehicles (e.g., one or more vehicles 140) are parked. The vehicle update location 135 can be, for example, a manufacturer re-flash yard, a car dealership, a parking deck, a home, etc. The vehicle update location 135 can contain a plurality of access points (APs) 150 that are used to form a mesh network for the vehicle update location. Accordingly, an AP 150 can act as a master WIFI device, while other APs 150 (satellite AP(s)), capture the signal of the master WIFI device and rebroadcast over a given area. The master WIFI device can be connected to the enterprise network 130 via a network connection (e.g., WIFI). The satellite APs 150 can be dispersed throughout the vehicle update location 135 in a predetermined pattern to create a plurality of hotspot zones in the vehicle update location 135.

An AP 150 assigned to a given hotspot zone can be connected to each of the one or more vehicles 140 via a network connection (e.g., WIFI) within the assigned hotspot zone. Each AP 150 can include a dual band transceiver that allows it to communicate on multiple wireless channels, such as the 2.4 GHz and 5 GHz frequency bands used by IEEE 802.11 (e.g., 802.11b/g/n and 802.11a/h/j/n/ac).

Each of the one or more vehicles 140 can be assigned to a designated hotspot zone and preprogrammed to connect to an AP 150 of the designated hotspot zone. Each of the one or more vehicles 140 can also be preprogrammed to operate in a factory mode in which the one or more vehicles 140 operate in a low power mode and are not in communication with the assigned AP 150. The one or more vehicles 140 can periodically enter a network/wakeup mode thereby causing the one or more vehicles 140 to communicate with the assigned AP 150 in order to cause an associated vehicle to receive a software updates (e.g., firmware, map, routing engine updates, etc.) from the enterprise network 130.

APs 150 for each hotspot zone in which a vehicle has entered a network/wakeup mode can communicate with the master WIFI device (AP 150) to initiate a first handshake, via the enterprise network 130, for vehicle registration using, for example, a dedicated key and credential registration file. The credential registration file can include, for example, a VIN number for an associated vehicle. Further communications used to accomplish the vehicle registration can be conducted via the cloud 110, the credential validation server 105 and external validation system 125.

The credential validation server 105 can be used to confirm a vehicle identification using the credential registration file. Once confirmed, the credential validation server 105 can instruct the cloud 110 to transmit a short message service (SMS) to the one or more vehicles 140 that have been validated, via the enterprise network 130. The cloud 110 can also perform a data allocation analysis to confirm network communications and bandwidth from the cloud 110 to the master WIFI device (AP 150). The data allocation analysis can be based on compute and network connectivity capabilities for the portion of the enterprise network 130 connected to a given master WIFI device (AP 150) to the cloud 110. The cloud 110 can use the data allocation analysis to separate the software update into predetermined portions/chunks for transmission to each of the one or more vehicles 140.

Upon confirmation of readiness for performing a software update by the master WIFI device (AP 150), the master WIFI device (AP 150) can transmit a confirmation back to the cloud 110 indicating that software update for the one or more vehicles 140 can proceed. The cloud 110 can transmit the one or more software updates to the enterprise network 130. The master WIFI device (AP 150) can also notify each of the one or more vehicles 140 that have been validated of an impending update. The notification can include a size of the update, a bandwidth that will be used for downloading the software update to an associated vehicle, and if other vehicles will be sharing the bandwidth. Each of the one or more vehicles 140 that have been validated can perform a download time prediction to determine how long a battery for the vehicle showed operate to allow the software update to be completed.

The master WIFI device (AP 150) can transmit/push the one or more software updates designated for a given vehicle to an AP 150 for a hotspot zone associated with the validated vehicle. During a software update download, if the vehicle determines that a time to download the one or more software updates exceeds the predicted time of battery use, the vehicle can cancel the one or more software updates and return to a previous software state.

The master WIFI device (AP 150) can cause software updates to be performed on all validated vehicles for a given vehicle update location 135 simultaneously using the APs 150 for all hotspot zones associated with all vehicles receiving software updates. The master WIFI device (AP 150) can also cause one or more software updates to be performed on vehicles receiving software updates per hotspot zone. The master WIFI device (AP 150) can also cause one or more software updates to be performed on a per vehicle basis. The master WIFI device (AP 150) can determine how the one or more software updates will be conducted (all, per zone, per vehicle) based on a size of the one or more software updates and an available bandwidth to perform software updates.

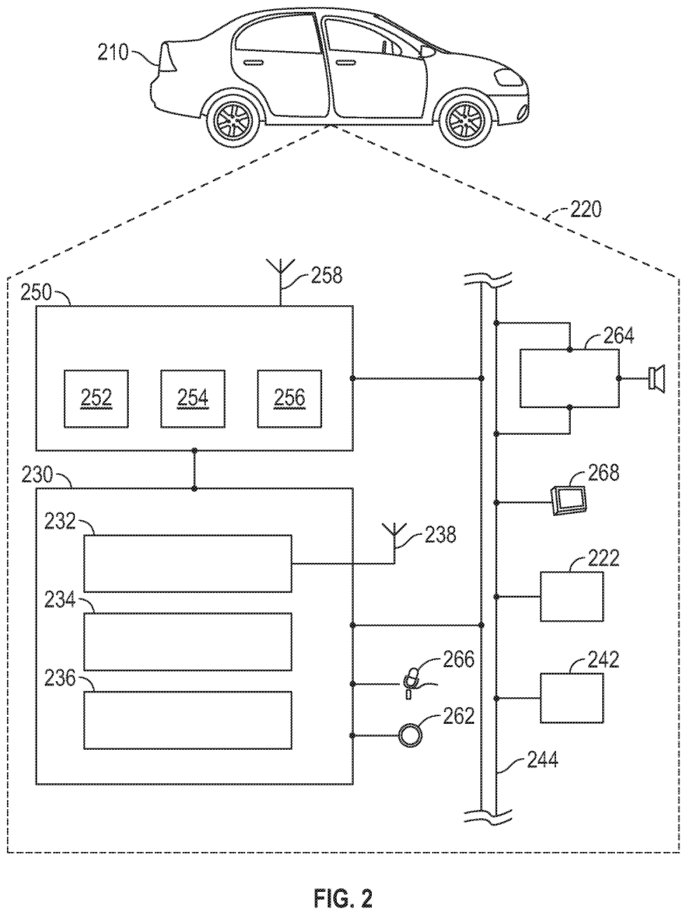

In accordance with an exemplary embodiment, FIG. 2 illustrates a vehicle communications system for implementing the teachings herein. Vehicle 210 can include the vehicle electronics 220.

Vehicle 210, which is equivalent to the one or more vehicles 140 and vehicle 145, is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 220 is shown generally in FIG. 2 and includes a telematics unit 250, an infotainment unit 230, a microphone 266, one or more pushbuttons or other control inputs 262, an audio system 264, a visual display 268, and a GPS module 222 as well as a number of other vehicle system modules (VSMs) 242. Some of these devices can be connected directly to the infotainment unit 230, such as, for example, the microphone 266 and pushbutton(s) 262, whereas others are indirectly connected using one or more network connections, such as a communications bus 244. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 250 can be an OEM-installed (embedded) or aftermarket device that is installed in the vehicle and that enables wireless voice and/or data communication via wireless networking. By providing both voice and data communication, telematics unit 250 enables the vehicle to offer a number of different services including those related to navigation, telephony, emergency assistance, diagnostics, infotainment, etc.

The telematics unit 250 utilizes cellular communication according to either GSM, CDMA, or LTE standards and thus includes a standard cellular chipset 252 for voice communications like hands-free calling, a wireless modem for data transmission, an electronic processing device 254, one or more digital memory devices 256, and a dual antenna 258. The modem can operate using any number of different standards or protocols such as LTE, EVDO, CDMA, GPRS, and EDGE.

Wireless networking between the vehicle and other networked devices (e.g., APs 150) can also be carried out using telematics unit 250. For this purpose, telematics unit 250 can be configured to communicate wirelessly according to one or more wireless protocols, including short-range wireless communication (SRWC) such as any of the IEEE 802.11 protocols, WiMAX, ZigBee™, WIFI, Bluetooth, or near field communication (NFC). The telematics unit may also communicate with other modules or devices of vehicle electronics 220 via a wired connection, such as via an Ethernet connection using IEEE 802.3 protocols. When used for packet-switched data communication such as TCP/IP, the telematics unit 250 can be configured with a static IP address or can set up to automatically receive an assigned IP address from another device on the network such as a router or from a network address server.

The processor 254 can be any type of device capable of processing electronic instructions including microprocessors, microcontrollers, host processors, controllers, vehicle communication processors, and application specific integrated circuits (ASICs). Processor 254 executes various types of digitally-stored instructions, such as software or firmware programs stored in memory 256, which enable the telematics unit to provide a wide variety of services.

Telematics unit 250 can be used to provide a diverse range of vehicle services that involve wireless communication to and/or from the vehicle. Such services include: turn-by-turn directions and other navigation-related services that are provided in conjunction with the GPS-based vehicle navigation module 222; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 250, but are simply an enumeration of some of the services that the telematics unit is capable of offering.

GPS module 222 receives radio signals from a constellation of GPS satellites. From these signals, the module 222 can determine vehicle position that is used for providing navigation and other position-related services to the vehicle driver. Navigation information can be presented on the display 268 (or other display within the vehicle) or can be presented verbally (e.g., turn-by-turn navigation.) The navigation services can be provided using a dedicated in-vehicle navigation module, which can be part of GPS module 222, or some or all navigation services can be done via telematics unit 250.

Position information can be sent to a remote location (e.g., cloud 110) for purposes of providing the vehicle with navigation maps, map annotations (points of interest, restaurants, etc.), route calculations, and the like. In addition, new or updated map data can be downloaded to the GPS module 222 using the telematics unit 250.

Besides the infotainment system 230, telematics unit 250, audio system 264, and GPS module 222, the vehicle 210 vehicle can include other vehicle system modules (VSMs) 242 in the form of electronic hardware components that are located throughout the vehicle 210 and typically receive input from one or more sensors and use the sensed input to perform diagnostic, monitoring, control, reporting and/or other functions. Each of the VSMs 242 can be programmed to run vehicle system and subsystem diagnostic tests.

One of the VSMs 242 can be an engine control module (ECM) that controls various aspects of engine operation such as fuel ignition and ignition timing, another VSM 242 can be a powertrain control module that regulates operation of one or more components of the vehicle powertrain, and another VSM 242 can be a body control module that governs various electrical components located throughout the vehicle, like the vehicle's power door locks and headlights. According to one embodiment, the engine control module can be equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle.

Infotainment unit 230 is included as part of vehicle electronics 220 and can be an OEM-installed (embedded) or aftermarket device that is installed in the vehicle. Infotainment unit 230 may control and/or provide numerous functions for the vehicle and is shown to include wireless access point (WAP) 232, processor 234, and memory 236. Infotainment unit 230 may be connected to a bus 244 and may control numerous vehicle modules and/or components, such as audio system 264, GPS 222, visual display 268 and/or other VSMs 242. Additionally, infotainment unit 230 may be directly connected to one or more devices or components, such as, for example, microphone 266, button 262, and telematics unit 250. Infotainment unit 230 may also receive information or data from any of the components of the vehicle 210 to which it may be communicatively connected to, including non-vehicle electronics that it may connect to, such as via WAP 232. The infotainment unit 230 is shown to include a processor 234 and memory 236, which allow the infotainment unit 230 to process and store information or data.

WAP 232 is shown to be included in infotainment unit 230; however, WAP 232 may be incorporated into a different module, such as telematics unit 250, or may be a stand-alone module. The vehicle WAP 232 may be coupled to a router or other network access device, such as telematics unit 250, which will allow it to connect to remote network(s). As shown, WAP 232 may include an antenna 238 to increase its reception and/or transmission of wireless signals and, in other embodiments, may include multiple antennas depending on, for example, the specific wireless protocol used (e.g., IEEE 802.11n). Additionally, WAP 232 may include a dual band transceiver that allows it to communicate on multiple wireless channels, such as the 2.4 GHz and 5 GHz frequency bands used by IEEE 802.11 (e.g., 802.11b/g/n and 802.11a/b/j/n/ac).

Vehicle electronics 220 also includes a number of vehicle user interfaces that provide vehicle occupants with a means of providing and/or receiving information, including microphone 266, pushbutton(s) 262, audio system 264, and visual display 628. Microphone 266 provides audio input to the telematics unit 250 to enable the driver or other occupant to provide voice commands and carry out hands-free calling. The pushbutton(s) 262 allow manual user input into the telematics unit 250 to initiate wireless telephone calls and provide other data, response, or control input. Audio system 264 provides audio output to a vehicle occupant and can be a dedicated, stand-alone system or part of the primary vehicle audio system. Visual display 268 is preferably a graphics display, such as a touch screen on the instrument panel or a heads-up display reflected off of the windshield, and can be used to provide a multitude of input and output functions.

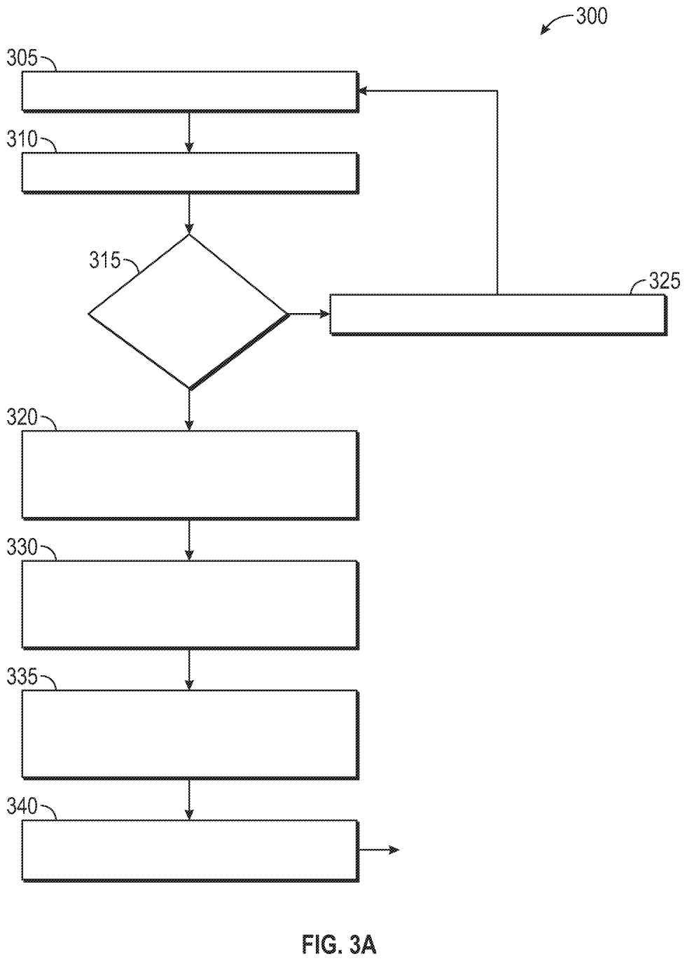

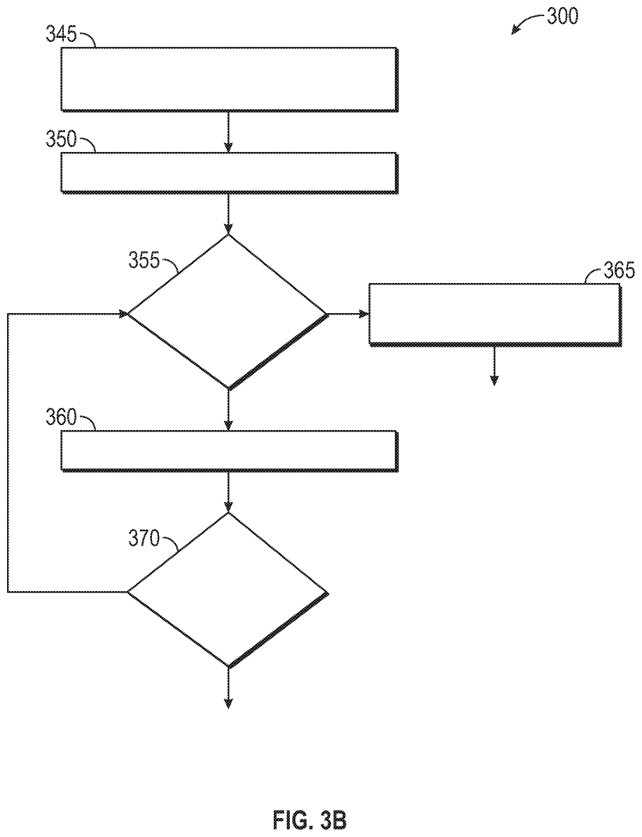

FIGS. 3A-3B depict first and second portions, respectively, of a flow diagram of a method 300 for implementing a method for providing a software update to a vehicle according to one or more embodiments. At block 305, a system, (e.g., vehicle communications system described in FIG. 2), a vehicle (e.g., vehicle 210) can enter a wakeup mode from a low power mode and/or factory mode. The vehicle can be located at a location in which communications via a hotspot is possible (e.g., vehicle update location 135). At block 310, the vehicle can register itself within a computing environment (e.g., computing environment 50), via one or more network connections, using, for example, a dedicated key and credential registration file. At block 315, the computing environment can determine whether the registered vehicle has been scheduled to receive one or more software updates (software update). If the vehicle has not been scheduled to receive a software update, the method proceeds to block 325, where the vehicle enters a low power mode and returns to block 305.

If the vehicle has been scheduled to receive a software update, the method proceeds to block 320, where the computing environment confirms the one or more updates that are associated with the vehicle based on the associated registration information for the vehicle. At block 330, upon conformation by the computing environment the computing environment can send a message (e.g., an SMS) to the vehicle notifying the vehicle of an impending software update. At block 335, the computing environment can perform a data allocation analysis throughout portions of the computing environment that will be used to facilitate the software update to determine compute and network connectivity capabilities. At block 340, the computing environment can transmit the software update to a master WIFI device at the location based on the data allocation analysis. At block 345, the vehicle can perform a download time prediction to determine how long a vehicle battery should be operable to complete a download of the software update to the vehicle from the master WIFI device or an associated WIFI device.

At block 350, the software update can be transferred to the vehicle. At block 355, during the transfer the vehicle can determine whether a transfer time for the software update has exceeded the download time prediction. If the transfer time has exceeded the download time prediction, the method proceeds to block 365 where the vehicle can cancel the transfer and return to a previous software state. The method then returns to block 325.

If the transfer time has not exceeded the download time prediction, at block 360, the vehicle can continue the transfer of the software update. At block 370, the vehicle can determine if the transfer of the software update is complete. If the transfer is not complete, the method returns to block 355. If the transfer is complete, the method returns to block 325.

Accordingly, the embodiments disclosed herein describe a system that enables remote access and on-demand software update based on the enterprise-provisioned WIFI networks. Embodiments disclosed herein can address the challenge of providing production line, dealership or home updates using an over-the-air (OTA) WIFI solution to conduct integrity test and content distributions to/from a vehicle manufacturer's computer network to one or more vehicles.

Technical effects and benefits of the disclosed embodiments include, but are not limited the system to enable a primitive WIFI substrate service and fast boot-up in a human machine interface inactive power mode, a secure software update process that is convenient (i.e., trust between a provisioned hotspot and client stations in the vehicle manufacturer's computer network), system verification of certificates and handshake configurations via local enterprise networks, and performs local and remote credentials check (i.e., synchronization of local information to remote record servers), dynamic OTA software update session management and rollback mechanisms in response to failures, a capability of combining vehicle registration and OTA update request in a single transaction (by defining new Remote-re-flash types to align TCP and other modules) and provides unique measurement data and connectivity plan for operating new manufacturing facilities (e.g., a more flexible WIFI deployment for an vehicle manufacturer's re-flash yard using a mesh network.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other devices to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method for providing a software update to a vehicle, the method comprising:
entering, by a vehicle, a wakeup state in a vehicle update location;
connecting, by the vehicle, to a designated access point among a plurality of access points positioned in the vehicle update location based on the location of the vehicle within the vehicle update location, wherein the plurality of access points include a master access point and form a mesh network in the vehicle update location;
sending, by the vehicle via the designated access point then the master access point, a vehicle registration request to a computing environment that tracks a current software version of the vehicle;
receiving, by the vehicle, a confirmation from the computing environment that the vehicle is to receive one or more software updates based on the vehicle registration of the vehicle; and
receiving, by the vehicle via the designated access point, the one or more software updates from the computing environment.

2. The method of claim 1, wherein the vehicle registration request includes a dedicated key and credential registration file.

3. The method of claim 1, wherein the confirmation is a short message service (SMS).

4. The method of claim 1 further comprising performing a data allocation analysis on a network associated with the computing environment.

5. The method of claim 4 further comprising transferring the one or more software updates based on compute and network connectivity capabilities determined in the data allocation analysis.

6-7. (canceled)

8. The method of claim 1 further comprising performing a download time prediction in response to receiving the one or more software updates.

9. The method of claim 8 further comprising canceling the one or more software updates in response to a transfer time exceeding the download time prediction.

10. A system for providing a software update to a vehicle, the system comprising:
the vehicle; wherein the vehicle comprises a memory and a processor coupled to the memory;
one or more servers, wherein each of the one or more servers comprise a memory and a processor coupled to the memory;
a plurality of access points positioned in a vehicle update location, wherein the plurality of access points include a master access point and form a mesh network in the vehicle update location;
wherein the processor of the vehicle is operable to:
cause the vehicle to enter a wakeup state in the vehicle update location;
send a vehicle registration request to the one or more servers via the master access point;
receive a confirmation that the vehicle is to receive one or more software updates based on the vehicle registration of the vehicle from the one or more servers that track a current software version of the vehicle; and
receive the one or more software updates from the one or more servers via a designated access point among the plurality of access points.

11. The system of claim 10, wherein the vehicle registration request includes a dedicated key and credential registration file.

12. The system of claim 10, wherein the confirmation is a short message service (SMS).

13. The system of claim 10, wherein a processor of the one or more servers is further operable to perform a data allocation analysis on a network associated with the computing environment.

14. The system of claim 13, wherein a processor of the one or more servers is further operable to transfer the one or more software updates based on compute and network connectivity capabilities determined in the data allocation analysis.

15-16. (canceled)

17. The system of claim 10, wherein the processor of the vehicle is further operable to perform a download time prediction in response to receiving the one or more software updates.

18. The system of claim 17, wherein the processor of the vehicle is further operable to cancel the one or more software updates in response to a transfer time exceeding the download time prediction.

19. A non-transitory computer readable medium having program instructions embodied therewith, the program instructions readable by a processor to cause the processor to perform a method for providing a software update to a vehicle, the method comprising:
entering a vvakeup state:
sending a vehicle registration request to a computing environment:
receiving a confirmation that the vehicle is to receive one or more software updates based on the v ehicle registration of the vehicle; and
receiving the one or more software updates from the computing env ironment.

20. The computer readable storage medium of claim 19 further comprising:
performing a data allocation analysis on a network associated with the computing environment; and
transferring the one or more software updates based on compute and network connectivity capabilities determined in the data allocation analysis.

21. A system for providing a software update to a vehicle, the system comprising:
one or more servers, wherein each of the one or more servers comprise a memory and a processor coupled to the memory;
a plurality of access points positioned in a vehicle update location, wherein the plurality of access points include a master access point and form a mesh network in the vehicle update location, the master access point obtains a vehicle registration request from the vehicle and provides it to the one or more servers, the one or more servers track a current software version of the vehicle and confirm that the vehicle is to receive one or more software updates based on the vehicle registration of the vehicle, and a designated access point among the plurality of access points provides the one or more software updates from the one or more servers to the vehicle.
